(19) United States
(12) Patent Application Publication
(10) Pub. No.: US 2011/0108688 A1
(43) Pub. Date: May 12, 2011

(54) Set-top box support kit for LCD wall mounts

(75) Inventor: Bidyut Parruck, Cupertino, CA (US)

(73) Assignee: Gazak Ventures Inc.

(21) Appl. No.: 12/590,572

(22) Filed: Nov. 9, 2009

(51) Int. Cl. F16M 13/00

(52) U.S. Cl. 248/217.4; 248/205.1

(57) ABSTRACT

A set-top box support kit for LCD wall mounts includes a container, support members and printed instructions. The support members attach to a user's pre-existing LCD wall mount and provide support for a set-top box. The LCD display attaches to the LCD wall mount and the set-top box is supported at an adjustable location near the perimeter of the display. An adjustment mechanism is provided so that a user may adjust the position of the set-top box in relation to the LCD display. The container provides for the storage and transport of the support member and printed instructions. Printed instructions inform the user on how to attach the support members to their LCD wall mount. A set-top box support kit allows a user to support their LCD display and set-top box on a single assembly.

### TECHNICAL FIELD

The described embodiments relate to wall mounts which support LCD displays and accessory devices.

### BACKGROUND INFORMATION

Entertainment systems often include set-top boxes which output video to an LCD display. Many users prefer to attach LCD display devices to their walls through an LCD wall mount assembly. By doing so, they do not require a separate piece of furniture to support the LCD display. Connection cables connect the LCD display to the set-top box, streaming video to the display. A set-top box must be in the proximity of an LCD display, otherwise the connection cables will not reach the LCD display. Since LCD wall mount assemblies only support displays, separate furniture is required to support the set-top box near the LCD display. Using separate furniture takes up more room space and may limit the user's options in situating their entertainment system. Additionally, if the set-top box is placed too far from the LCD display, connection cables may stretch across a room. Such a setup is visually unappealing and a dangling cable can be a danger since someone could trip over it. In addition to connection cables, a set-top box or similar device requires its own power cables to be connected to an electrical power outlet. A set-top box nearer to the LCD display will help group all the power cables and minimize the number of separate outlets used to power the entertainment system.

### SUMMARY

A set-top box support kit for an LCD wall mount assembly allows a user to support a set-top box to their existing LCD wall mount assembly. A set-top box support kit for an LCD wall mount assembly provides the user with a support member to attach to their existing setup, which will support their set-top box. A set-top box support kit comprises a container, support members and printed instructions. Support members attach to the user's LCD wall mount and support the set-top box. An adjustment mechanism is provided so the user may adjust the position of the set-top box. A container is used to store and transport the support members and the printed instructions. Printed instructions explain to the user how to attach the support members to their LCD wall mount. Support members support the set-top box above, below, or beside the display. This provides a more visual appealing entertainment system. Since the set-top box is near the display, connection cables easily reach between both devices. Additionally, a user is not required to purchase separate furniture to support their set-top box near the LCD display.

In another embodiment, a modified LCD wall mount supports a display to a wall or surface and also provides support members to support a set-top box. In this embodiment, the support members are formed on the LCD wall mount forming a single structure. A modified LCD wall mount does not require a user to purchase a kit to support the set-top box, since the support is part of the LCD wall mount structure. The modified LCD wall mount supports both the display and the set-top box on the same assembly. In one embodiment, the modified LCD wall mount supports the set-top box hidden behind the display. A user is unable to control the set-top box with a remote control, because it is hidden from view, so an IR repeater is used. An IR repeater sensor is placed above the display, and the signal is propagated to the set-top box through a separate cable. Connection cables easily reach between the set-top box and the display, because both devices are situated near each other. The modified LCD wall mount saves the user space, since no extra furniture is needed to support the set-top box.

Further details and embodiments and methods are described in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 (prior art) is an illustration of the video flat panel display device attached to a flat panel display wall mount.

FIG. 2 (prior art) is a diagram of an exploded perspective view of a flat panel display wall mount.

FIG. 3 (prior art) is a diagram of a top perspective view of the wall mount after it is setup by a user.

FIG. 4 (prior art) is a diagram of a back perspective view of the wall mount after it is setup by a user.

FIG. 5 is a diagram of a top perspective view of a kit embodiment.

FIG. 6 is a diagram of an exploded perspective view of the kit of FIG. 5.

FIG. 7 is a diagram of an exploded perspective view of the flat panel display wall mount with the angled bars installed, and the display and accessory device attached.

FIG. 8 is a diagram of an exploded perspective view of the installed kit.

FIG. 9 is a diagram of a back perspective view of the installed kit.

FIG. 10 is a diagram of a top perspective view after the kit is installed by the user.

FIG. 11 is a diagram of the side perspective view after the kit is installed by the user.

FIG. 12 is a diagram of a front perspective view after the kit is installed by the user.

FIG. 13 is a diagram of an expanded perspective view of the angled bars.

FIG. 14 (another embodiment) is a diagram of an exploded perspective view of another embodiment, with the display and accessory device attached to the wall mount.

FIG. 15 is an expanded perspective diagram of the adjustment mechanism of FIG. 14.

FIG. 16 is a diagram of a back perspective view after the display and accessory device are attached to the wall mount.

FIG. 17 is a diagram of a side perspective view of the embodiment after the display and accessory device are attached to the wall mount.

FIG. 18 (another embodiment) is a diagram of a side perspective view of another embodiment, with the display device and accessory device attached to the wall mount.

FIG. 19 is a diagram of a back perspective view of the embodiment of FIG. 18, with the display and accessory device attached.

FIG. 20 is a diagram of a side perspective view of the embodiment of FIG. 18 with the display and accessory device attached.

FIG. 21 is a diagram of a top perspective view of the embodiment of FIG. 18 with an IR repeater system attached.

FIG. 22 is a diagram of a front perspective view of the embodiment of FIG. 18 with the attached IR repeater resting on the upper extent of the display.

FIG. 23 (another embodiment) is a diagram of another embodiment which supports a display, an accessory device and a remote control.

FIG. 24 is a diagram of an exploded perspective view of the installed assembly of FIG. 23.

FIG. 25 is a diagram of an expanded back perspective view of the trough of FIG. 23.

FIG. 26 is a diagram of an expanded top perspective view of the trough of FIG. 23.

FIG. 27 (another embodiment) is a diagram of an exploded perspective view of another embodiment providing the user with a kit to attach to a flat panel display wall mount, so that the wall mount supports an accessory device and a display.

FIG. 28 (another embodiment) is a diagram of an exploded perspective view of another embodiment, which provides the user with a kit to attach a display and an accessory device to a wall mount.

FIG. 29 is a diagram of the side perspective view of the embodiment of FIG. 28, after the kit is installed and the accessory device and display are attached.

FIG. 30 is a diagram of the front perspective view of the embodiment of FIG. 28, as viewed by a user after the kit is installed and the accessory device and display are attached.

FIG. 31 (another embodiment) is an exploded perspective diagram of another embodiment, which provides the user with a kit to attach a display and an accessory device to a wall mount.

FIG. 32 is a diagram of the top perspective view of the embodiment of FIG. 31 after the kit is attached to the wall mount and the accessory device and display are attached.

FIG. 33 is a diagram of the front perspective view of the embodiment of FIG. 31 as seen by a user facing the display, after the kit is attached to the wall mount and the accessory device and display are attached.

FIG. 34 is a diagram of the side perspective view of the embodiment of FIG. 31, after the kit is attached to the wall mount, and the accessory device, remote control, and display are attached.

FIG. 35 is a diagram of an exploded perspective view of the support member of FIG. 31.

FIG. 36 is a flowchart of a method in accordance with one novel aspect.

FIG. 37 is a flowchart of a method in accordance with one novel aspect.

FIG. 38 is a flowchart of a method in accordance with one novel aspect.

### DETAILED DESCRIPTION

Reference will now be made in detail to some embodiments of the invention, examples of which are illustrated in the accompanying drawings.

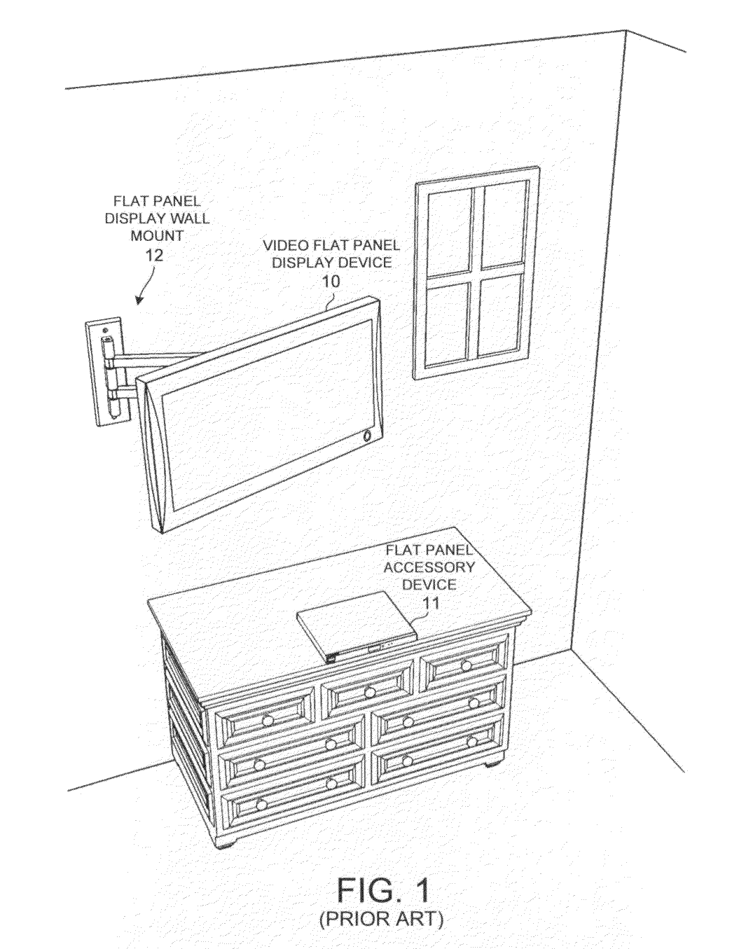

FIG. 1 (prior art) is an illustration of the video flat panel display device 10 attached to a flat panel display wall mount 12. The flat panel display wall mount 12 is attached to a wall, and the video flat panel display device 10 is attached to the flat panel display wall mount 12. This allows the video flat panel display device 10 to be suspended to a wall or surface. The flat panel accessory device 11 rests on a drawer, a separate surface not attached to the flat panel display wall mount 12. A flat panel accessory device 11 may be a set-top box or any similar device that is used in concert with the video flat panel display device 10. Some examples of an accessory device 11 include video output devices (such as Blue-Ray DVD players, DVD players, VCRs, Apple TV, IPTV box, Ruku box, Hulu.com box or similar devices) or video game consoles (such as Xbox, PlayStation 3, Wii or similar devices). After the user attaches the video flat panel display device 10 to a wall using the flat panel display wall mount 12, the user then finds a location to place the flat panel accessory device 11. The flat panel accessory device 11 must be situated such that the connection cables can connect between the flat panel accessory device 11 and the video flat panel display device 10 (connection cables are not depicted in the drawing). If they are located too far apart, then the connection cables may not reach the distance between the two devices.

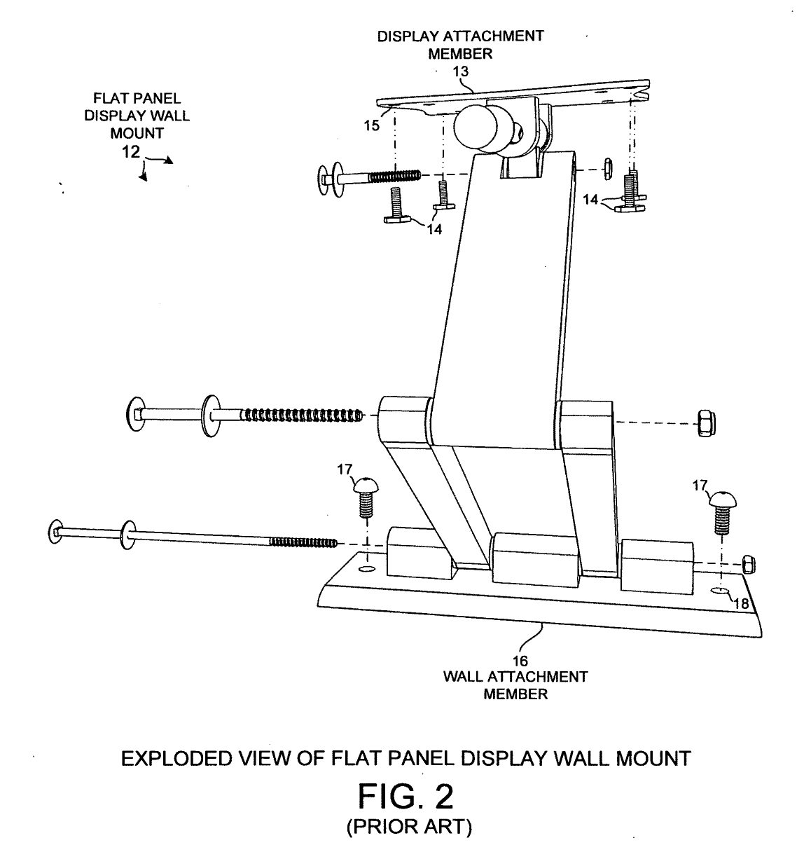

FIG. 2 (prior art) is a diagram of an exploded perspective view of a flat panel display wall mount 12. Display attachment member 13 attaches to a video flat panel display device 10, by a plurality of screws 14. Display attachment member 13 has a plurality of holes 15 which are used to attach display attachment member 13 to the video flat panel display device 10. In one example, the display attachment member 13 has two sets of four holes. The inner-set of four holes form a square, wherein an edge is approximately 3 inches in length (constituting the hole-to-hole distance). The outer-set of four holes are also form a square, wherein the edge is approximately 4 inches in length (constituting the hole-to-hole distance). Screw 14 passes through hole 15 (insertion path is depicted in FIG. 2 for each of four screws) and then screws into a receiving threaded slot on the surface of the video flat panel display device 10. The wall attachment member 16 attaches to the wall or surface. Screw 17, passes through hole 18 (insertion path shown in FIG. 2), and then screws into the desired wall or surface.

Various joints are shown where screws, washers and nuts connect different components together. Insertion paths for each screw, bolt and nut are shown in FIG. 2. These joints allow the components to rotate about the center of the joint. By providing these pivot or swivel points along various locations along the flat panel display wall mount 12, the user is able to adjust the location of the video flat panel display device 10 to a desired location. In other flat panel display wall mount assemblies, there may be less joints allowing the user less options in positioning the video. Other assemblies may not utilize screws and bolts to connect components of the assembly together. Other assemblies may be structured differently than the assembly depicted, having fewer or more components, different attaching mechanisms, and allow for different types of movement between components.

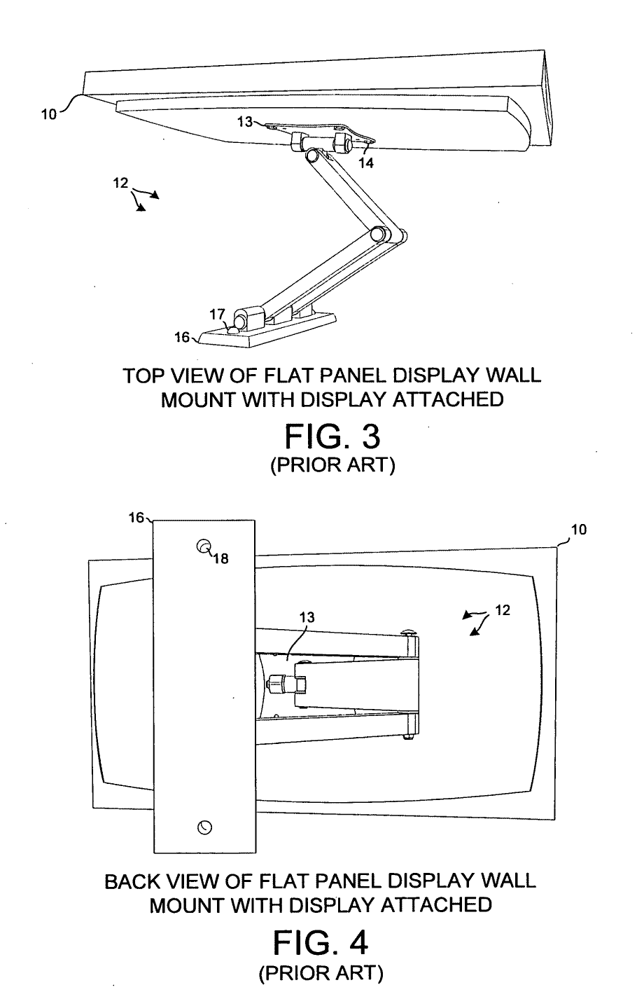

FIG. 3 (prior art) is a top view diagram of the wall mount 12 after it is setup by a user. A flat panel display 10 is attached to a wall (not shown) through the wall mount 12. The flat panel display 10 is attached to the display attachment member 13 of the wall mount 12 through four screws 14. The wall mount 12 is attached to the wall (not shown) through the wall attachment member 16 with two screws 17. A user is able to make various adjustments along the wall mount 12 at various joint locations. By performing such adjustments, the user is able to situate the wall mount 10 at desired position or viewing angle.

FIG. 4 (prior art) is a diagram of a back perspective view of the wall mount 12 after it is setup by a user. The flat panel display 10 is attached to the display attachment member 13 which is attached to the wall mount 12. The surface attachment member 16 attaches to a wall (not shown) through two screws (not shown) which pass through holes 18. The user is able to make adjustments at the various joints of the wall mount 12 in order to situate the flat panel display 10 at a desired position or viewing angle.

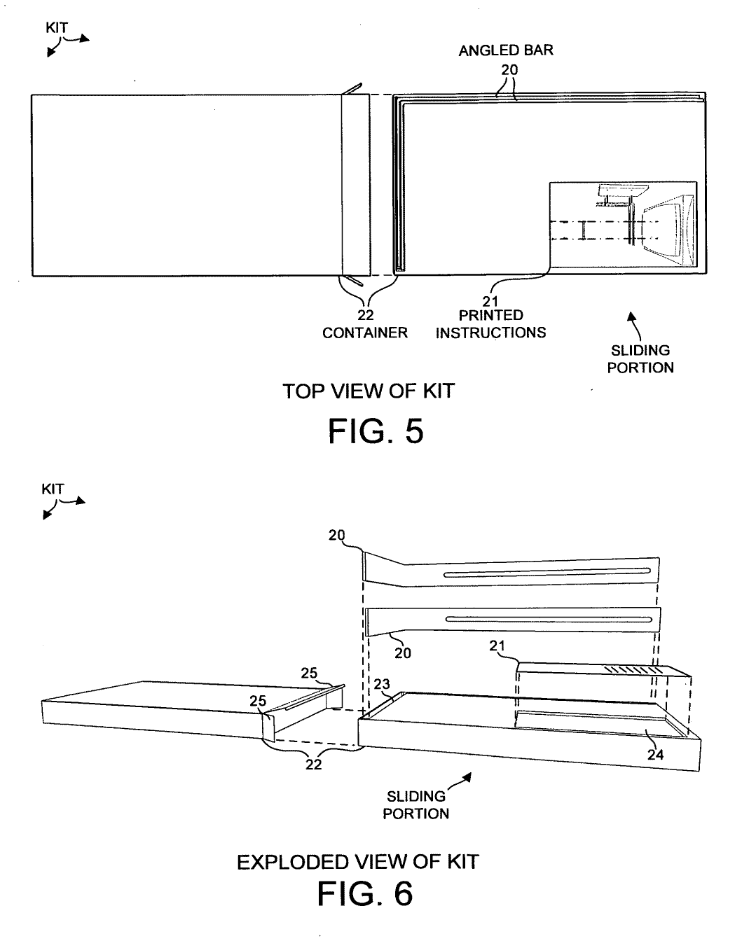

FIG. 5 is a diagram of a top perspective view of a kit. The kit allows a user to attach flat panel accessory device support members 20 to a flat panel display wall mount 12. In one embodiment, a kit is comprised of flat panel accessory device support members 20, printed instructions 21, and a container 22. In this embodiment, the flat panel accessory device support member 20 is an angled bar. Printed instructions 21 inform the user on how to attach the angled bars 20 to their flat panel display wall mount 12. In this embodiment, a sliding portion of container 22 is comprised of a foam material and supports the printed instructions 21 and angled bars 20. Sliding portion of container 22 retains these components and prevents them from being damaged when the kit is transported. Sliding portion of container 22 slides into the other portion of container 22 forming a single package. The packaged kit can then be easily transported, shipped or stored. A user can slide out one portion of container 22, and can access and utilize the printed instructions 21 to install the angled bar 20 onto their flat panel display wall mount 12. After installation, a user can support a flat panel accessory device 11 on top of the angled bars 20.

FIG. 6 is a diagram of an exploded perspective view of the kit in FIG. 5. Two angled bars 20 fit into slot 23 in the sliding portion of container 22. Printed instructions 21 fit into slot 24 in the sliding portion of container 22. After angled bars 20 are placed into slot 23 and printed instructions 21 are placed into slot 24, the sliding portion of container 22 can then be inserted into the other portion of container 22 so that the kit forms a single package. Flaps 25 of the container then secures the inserted portion so that it does not fall out when the packaged kit is transported. The packaged kit can then be shipped to a user or stored by a user in their household without damaging or losing components of the kit.

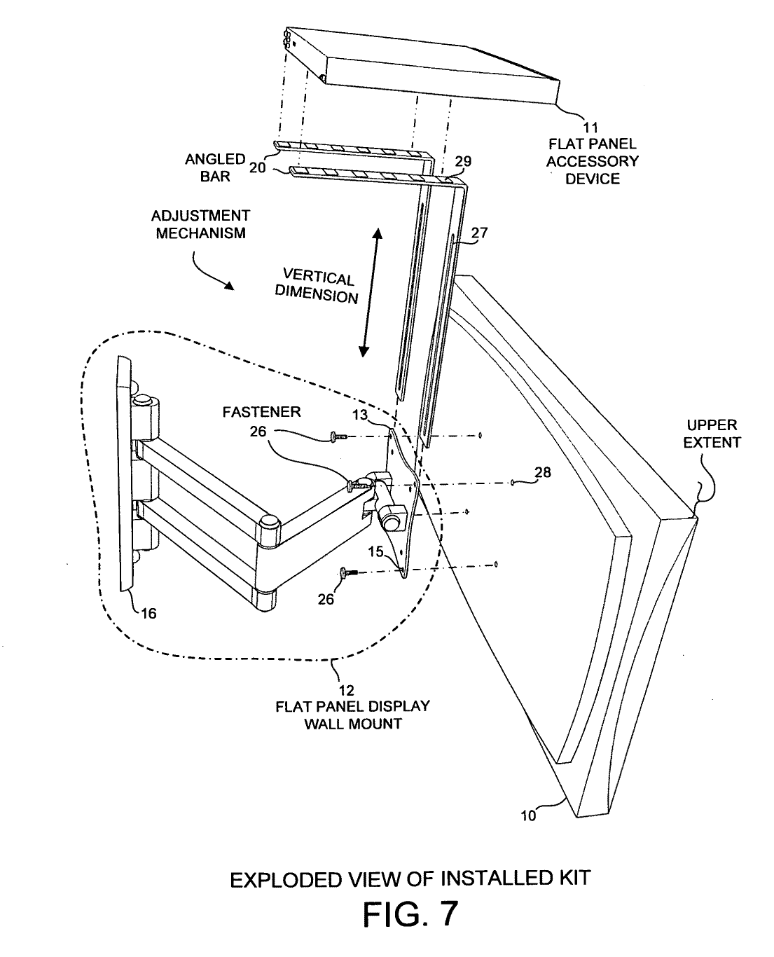

FIG. 7 is a diagram of an exploded perspective view of the flat panel display wall mount 12 with the angled bars 20 installed, and flat panel accessory device 11 and video flat panel display device 10 attached to the assembly. Each angled bar 20 forms a slit along one portion of the angled bar 20. Fasteners 26 are used to contain the angled bars 20 between the display attachment member 13 (of the wall mount 12) and the flat panel display 10. Four fasteners 26 pass through the four corresponding holes 15 on the display attachment member 13, then pass through slits 27 on the angled bars 20, and then screw into the corresponding four threaded holes 28 on the back of the flat panel display 10. Fasteners 26 cause angled bars 20 to be sandwiched between the flat panel display 10 and the display attachment member 13, and retain angled bars 20 in position. Upper extent of angled bar 20 retains a flat panel accessory device 11 such that it rests above it. The upper extent of angled bars 20 dispose a plurality of non-slip portions 29, which help prevent the accessory device 11 from slipping. The non-slip pads 29 may contain rubber or a similar material which retain the accessory device 11 in place. Other kit embodiments may include more mechanisms utilized to retain the accessory device 11, such as Velcro, straps, or screws. Such techniques provide the user more security in supporting the accessory device 11 on top of the support members 20.

An accessory device 11 rests above the angled bars 20 such that the accessory device 11 is disposed above the upper extent of the flat panel display 10. The position at which the accessory device 11 is disposed above the upper extent of the flat panel 10 is adjusted by a user through the adjustment mechanism. After angled bars 20 are positioned in between the wall mount 12 and the flat panel display 10, they can be adjusted in a vertical dimension. By loosening the four screws 26, the angled bars 20 slide up and down in a vertical dimension, providing an adjustment mechanism to the user. As angled bars 20 are slidably engaged along the vertical dimension, the accessory device 11 which is supported by the angled bars 20, also changes position. A user can slidably engage the angled bars 20, thereby adjusting the position of the accessory device 11 as it is disposed above the upper extent of the display device 10. Such a mechanism allows the angled bars 20 to dispose the accessory device 11 so that it is just above the flat panel display 10 and the user is able to control it with a remote control. Slits 27 on the angled bars 20, allow for support of a set-top box on a wide range of flat panel sizes, since they can be adjusted up and down until the accessory device 11 is properly situated just above the upper extent of the display.

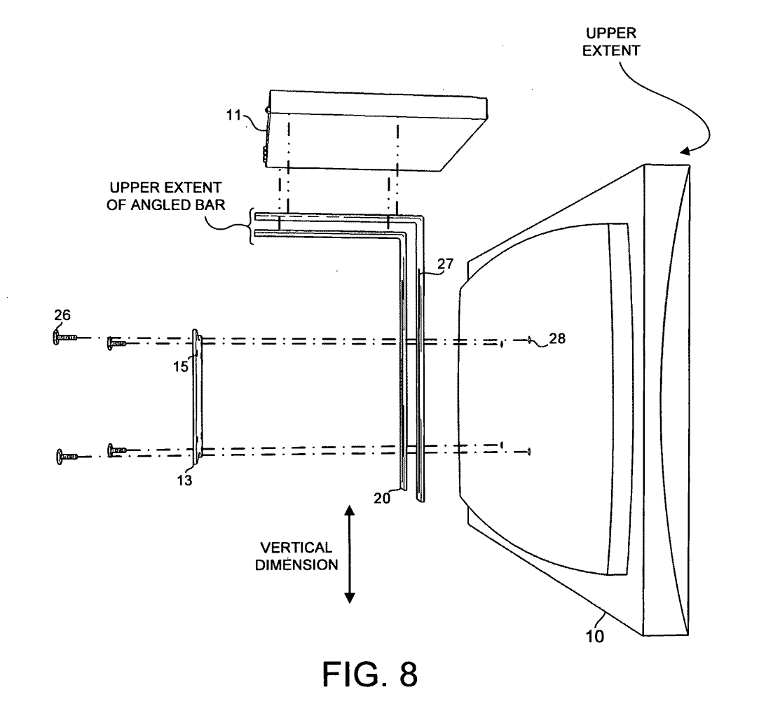

FIG. 8 is a diagram of an exploded perspective view of the kit installation. Only the display attachment member 13 component of the wall mount 12 is shown. Screws 26 pass through holes 15 on the display attachment member 13, then pass through slits 27 on angled bars 20, and finally screw into the receiving threads 28 on the back surface of the flat panel display 10. The accessory device 11 rests above the upper extent of angled bars 20, and is disposed above the upper extent of the flat panel display 10. Angled bars 20 can be slidably engaged along the display attachment member 13, causing the upper extent of the angled bars 20 to move along a vertical dimension. Since the accessory device 11 rests on the angled bars 20, as the angled bars 20 are adjusted, so is the accessory device 11. Accessory device 11 can be adjusted along a vertical dimension, and can be disposed above the upper extent of the display 10 such that the infrared receiver of the accessory device 11 is accessible to a user through a remote control. If the accessory device 11 were too low and hidden behind the flat panel device 10, then the user could not utilize the device with their remote control. Such an adjustment mechanism also allows the kit to support a wide range of flat panel sizes, since the length of slits 27 support wide ranges of movement along the vertical dimension.

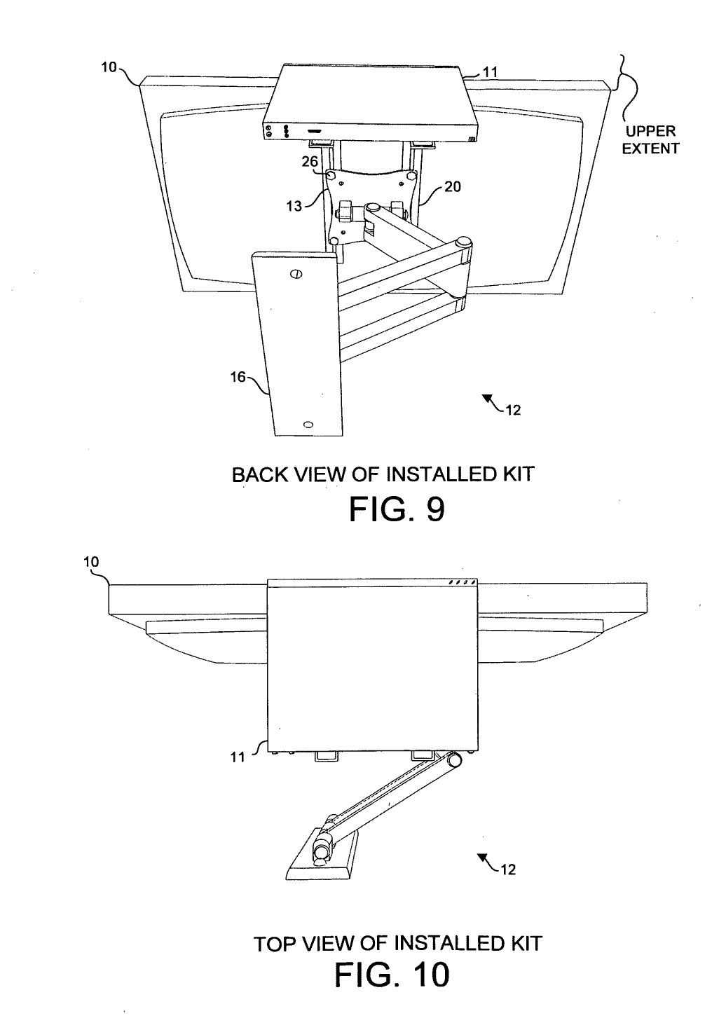

FIG. 9 is a diagram of a back perspective view of the installed kit. Accessory device 11 is supported by the angled bars 20. Screws 26 secure the angled bars 20 between the display attachment member 13 and the flat panel display 10. The accessory device 11 is disposed above the upper extent of the display 10. The accessory device 11 may be moved up and down along the upper extent of the display device 11, by slidably engaging the angled bars 20 along the display attachment member 13. The surface attachment member 16 can then be attached to a wall, so that the flat panel display 10 and the accessory device 11 are supported by the wall mount 12. By utilizing the kit, the user does not require a separate surface to support the accessory device. The user can alter the position of the display by making adjustments at various joints along the wall mount 12.

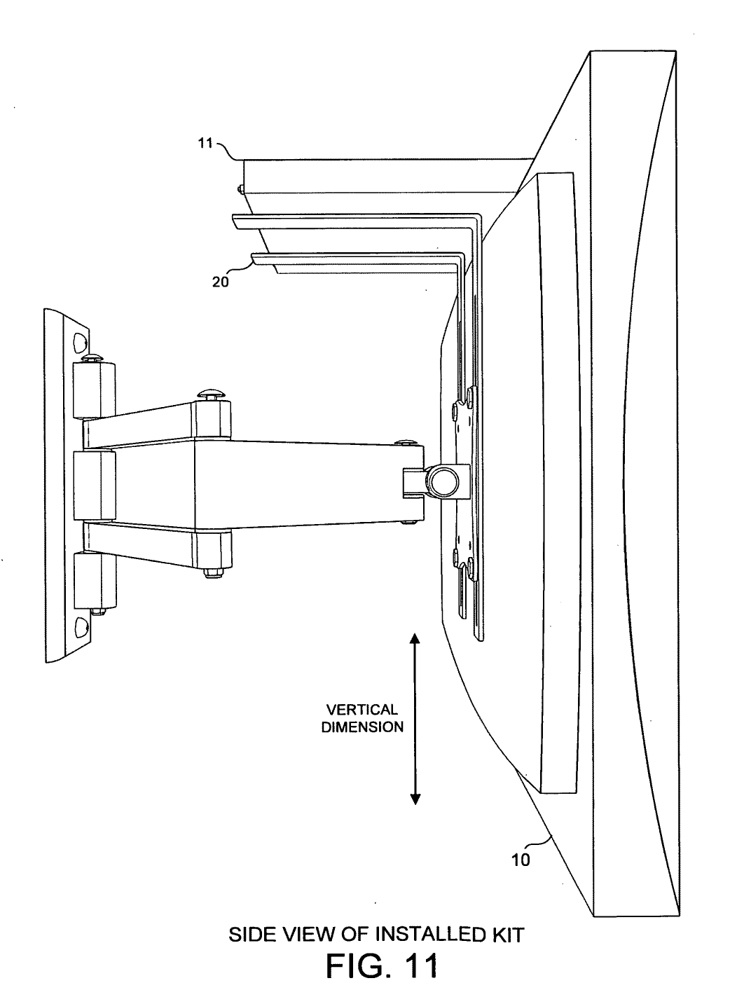

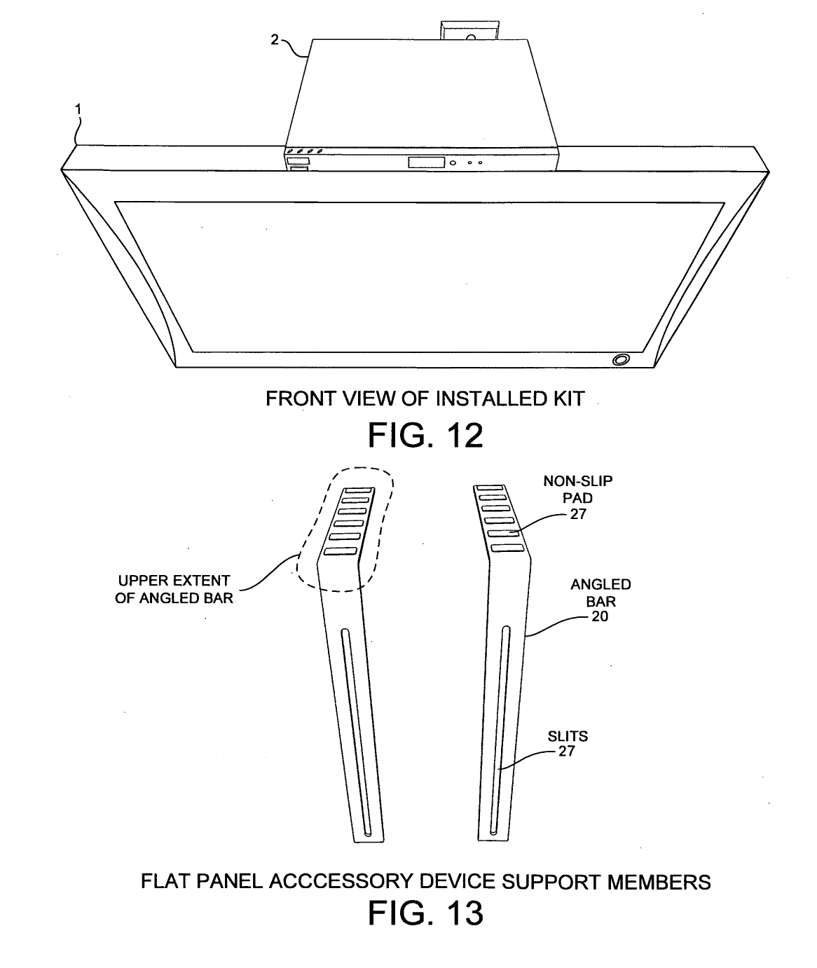

FIG. 10 is a diagram of a top perspective view after the kit is installed by the user. FIG. 11 is a side perspective diagram of the installed kit. FIG. 12 is a front perspective diagram of the installed kit. Power cables and connectors are omitted from the drawings.

FIG. 13 is an expanded view of the angled bars 20. The accessory device 11 rests above the upper extent of the angled bars 20. Screws pass through slits 27, retaining the angled bars 20 in position and supporting the accessory device 11 to the wall mount 12. In one embodiment, support members are 8 inches long. Typically, support members are at least 5 times longer than the smallest dimension of the support member. However, the dimensions of support members (and of LCD wall mounts) are highly variable and are dependent on the target LCD screen size. LCD screen sizes can be as wide as 10 inches or as wide as 70 inches. The bent portion of the support member (forming the upper extent which provides the set-top box support) is typically greater than 2 inches since most set-top boxes are more than 2 inches in length or width and are supported by the bent portions. In terms of thickness, a thin support member is desired to minimize material cost and weight, but not at the expense of structural integrity.

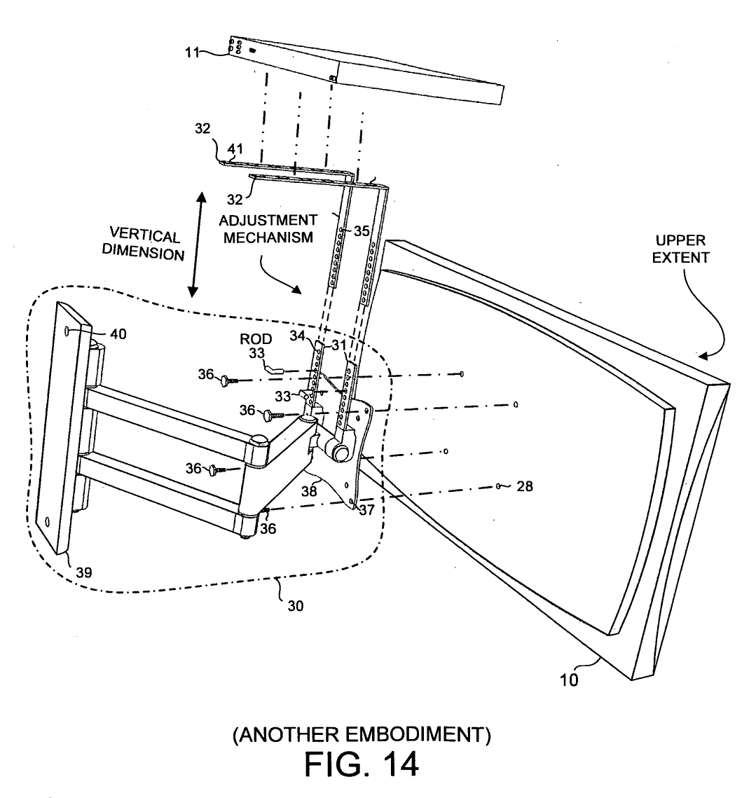

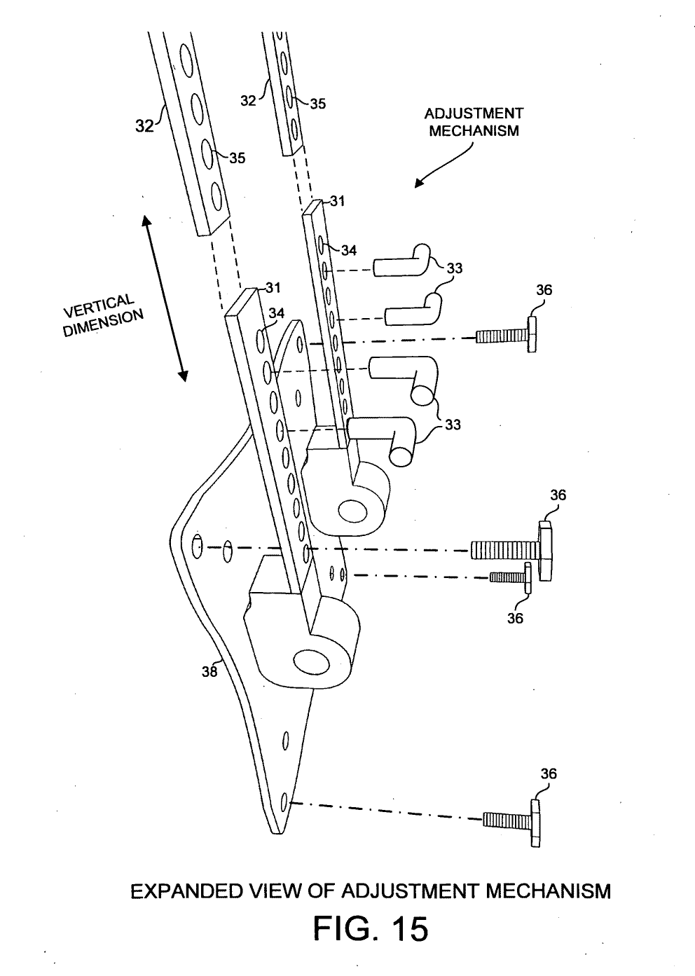

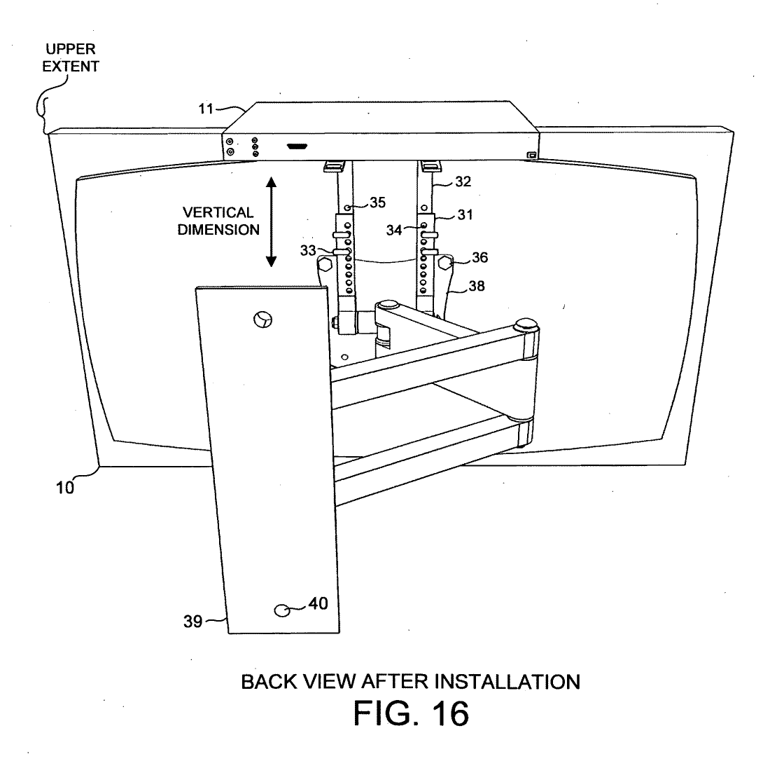

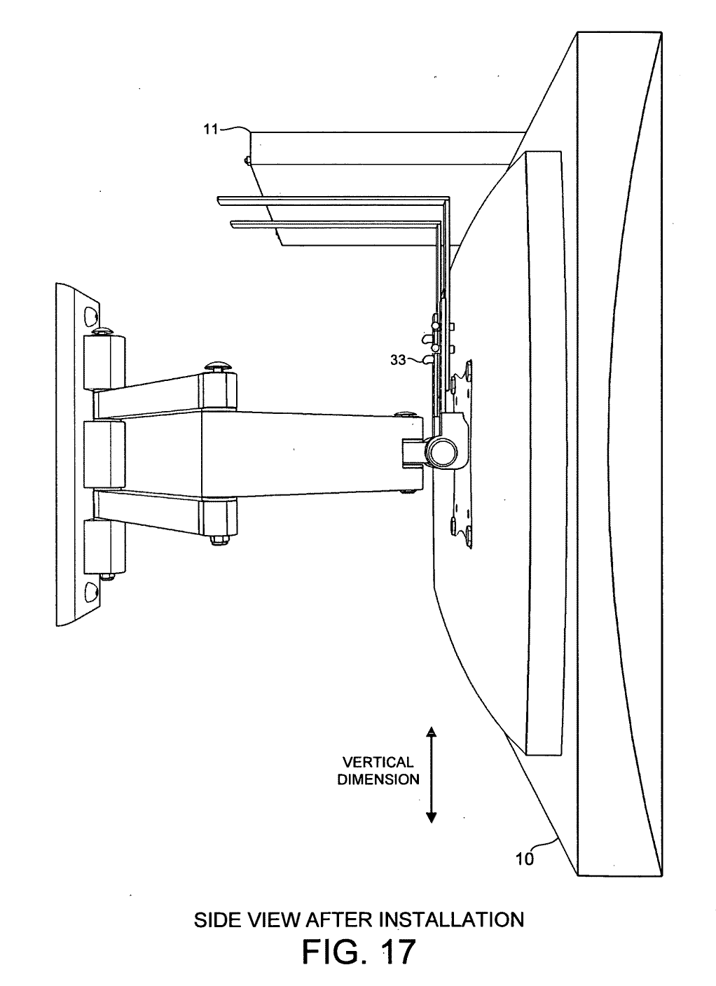

FIG. 14 is a diagram of an exploded perspective view of another embodiment with the flat panel accessory device 11 and video flat panel display device 10 attached to the wall mount 30. In this embodiment, extending adjustment bars 31 are integrally formed on the wall mount 30, and provide the user with an adjustment mechanism. The flat panel accessory device support member 20 is an angled bar. Angled bars 32 slidably engage the extending adjustment bars 31 so that a user is able to adjust the angled bars 32 in a vertical dimension. The angled bars 32 support the accessory device 11, such that the user may position the accessory device 11 above the upper extent of the display 10. The user positions the accessory device 11 in the appropriate location using rods 33. Rods 33 lock angled bars 32 in position so that they do not move and can retain the accessory device 11 in place. Rods 33 pass through one of a plurality of holes 34 on the extending adjustment bars 31, and then pass through one of a plurality of holes 35, keeping the angled bars 32 locked in position. FIG. 14 only shows two rods, however, four rods are provided to the user to pass through two other holes as described above (and as depicted in FIG. 15, FIG. 16, and FIG. 17), ensuring the angled bars are stable and are maintained upright in the vertical dimension.

The display 10 is attached by fasteners 36 to the display attachment member 38 of the wall mount 30. Fasteners 36 pass through holes 37 on the display attachment member 38, and then screw into threaded holes 28 located on the back of the display 10. The wall mount 30 is attached to a wall or surface through the surface attachment member 39. Two screws (not shown) pass through holes 40 located on the surface attachment member 39, and screw into the surface. Consequentially, the display 10 and accessory device 11 are suspended to the wall or surface. By using the adjustment mechanism, the user may remove the rods 33, slide the angled bars 32 to position, and then insert the rods 33 back through holes 34 and holes 35 to lock it in position. The user can use this adjustment mechanism to position the accessory device 11 at the desired location above the upper extent of the display 10. Non-slip pads 41 located on the top surface of angled bars 32 help prevent the accessory device 11 from slipping. Other embodiments may include other mechanisms for keeping the accessory device in place, such as screws, Velcro or straps.

FIG. 15 is a diagram of an expanded perspective view of the adjustment mechanism. Extending adjustment bar 31 is integrally formed on the surface attachment member 38 and has a plurality of holes 34 giving the user several options for positioning the angled bar 32. The user slides angled bars 32 up and down in the vertical dimension to a desired location, then rods 33 are used to lock the angled bars 32 in position. Two rods 33 keep each angled bar 32 in place. The rods 33 lock the angled bars 32 by passing through holes 34 on the extending adjustment bar 31 and then through holes 35, effectively attaching angled bars 32 to the extending adjustment bars 31. Fasteners attach the surface attachment member 38 to the back surface of the display, as shown in FIG. 14.

FIG. 16 is a diagram of a back perspective view after the display 10 and accessory device 11 attached to the wall mount 30. Angled bars 32 support the accessory device 11 above the upper extent of the display 10. Rods 33 attach angled bars 32 to extending adjustment bars 31, effectively attaching the angled bars 32 to the wall mount 30. The user may remove the rods 33 from the holes and may slide the angled bars 33 up and down in a vertical dimension. By altering the position of the angled bars 32, the user may position the accessory device 11 at the desired position above the upper extent of the display 10. Screws 36 connect the display attachment member 38 to the display 10. The wall mount 30 is attached to a wall through the surface attachment member 39 using screws which pass through holes 40. FIG. 17 is a side perspective of the embodiment after the display 10 and accessory device 11 are attached to the wall mount 30.

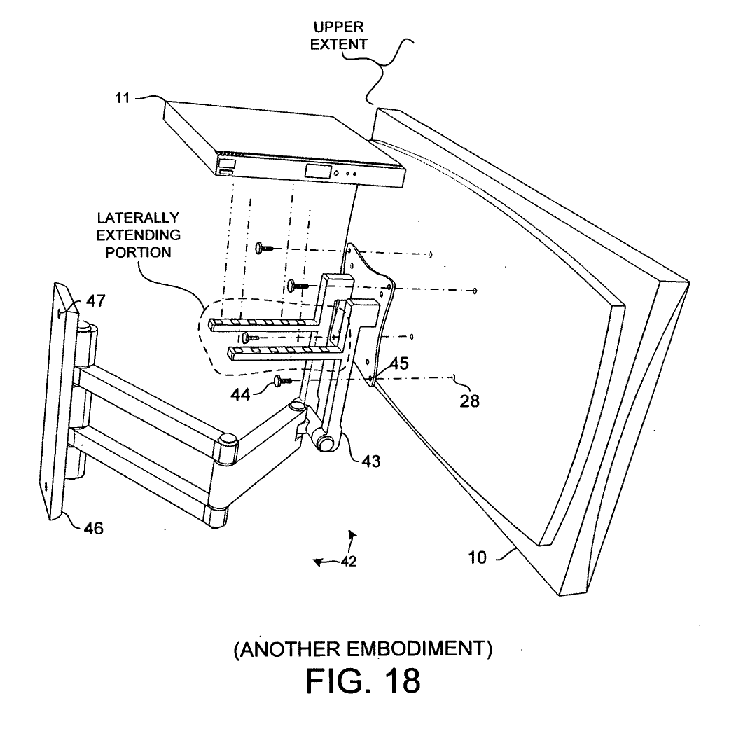

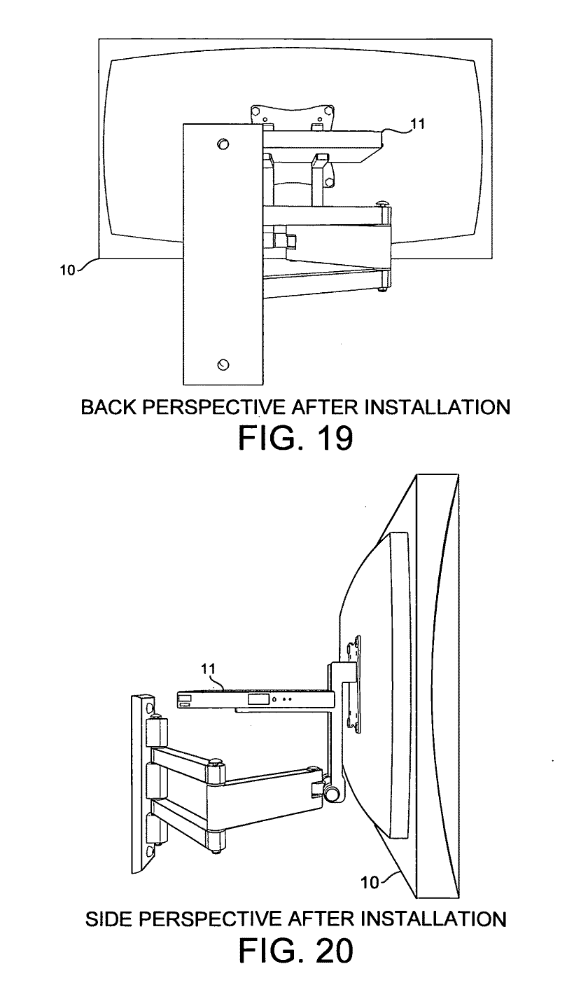

FIG. 18 is a diagram of a side perspective view of another embodiment, with the video flat panel display device 10 and flat panel accessory device 11 attached to the flat panel display wall mount 42. Accessory device 11 rests on the laterally extending portion of the wall mount 42. The laterally extending portions are integrally formed on the display attachment member 43 and support the accessory device 11. Screws 44 attach the display device 10 to the wall mount 42. Four screws 44 pass through four holes 45 (on the display attachment member 43) and screw into threaded holes 28 on the display 10. Surface attachment member 46 attaches the wall mount 42 to the wall, through screws (not shown) which pass through the holes 47. FIG. 19 is a back perspective of the wall mount 42 with the display 10 and accessory device 11 attached. FIG. 20 is a side perspective of the wall mount 42 with the display 10 and accessory device 11 attached. As the accessory device 11 is attached to the wall mount, the accessory device 11 is hidden behind the display 10 and is not visible. Because the device is hidden, a user facing the display can not control the accessory device 11 with a remote control since the IR receiver located on the accessory device 11 will be hidden from view. An IR repeater is used so that a user may control the accessory device 11 despite being hidden from view.

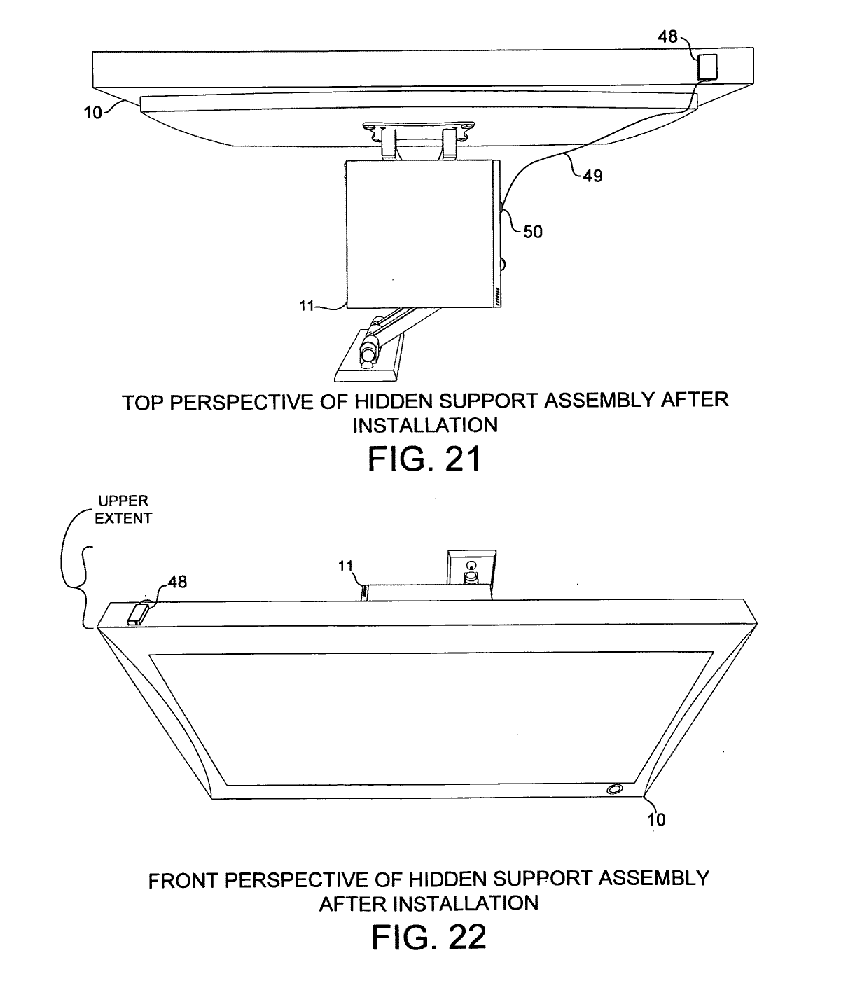

FIG. 21 is a diagram of a top perspective view of the wall mount 42 with an attached IR repeater 48 resting on the upper extent of the display 10. IR repeater 48 receives the IR signal from the user's remote control and propagates the signal through cable 49 to terminal 50 on the accessory device 11. The signal is propagated to the IR receiver of the accessory device 11. This allows the user to control the accessory device 11 despite being hidden behind the display 10. FIG. 22 is a front perspective of the wall mount 42 with the attached IR repeater 48 resting on the upper extent of the display 10. The accessory device 11 rests on the wall mount 42 and a user is able to control the device as if it were within the user's line of sight. Different embodiments may use different methods of propagating the signal between the user's remote control and the accessory device 11 depending on the type of technology the accessory device uses to communicate with the remote control. Power and connection cables are omitted from the diagrams.

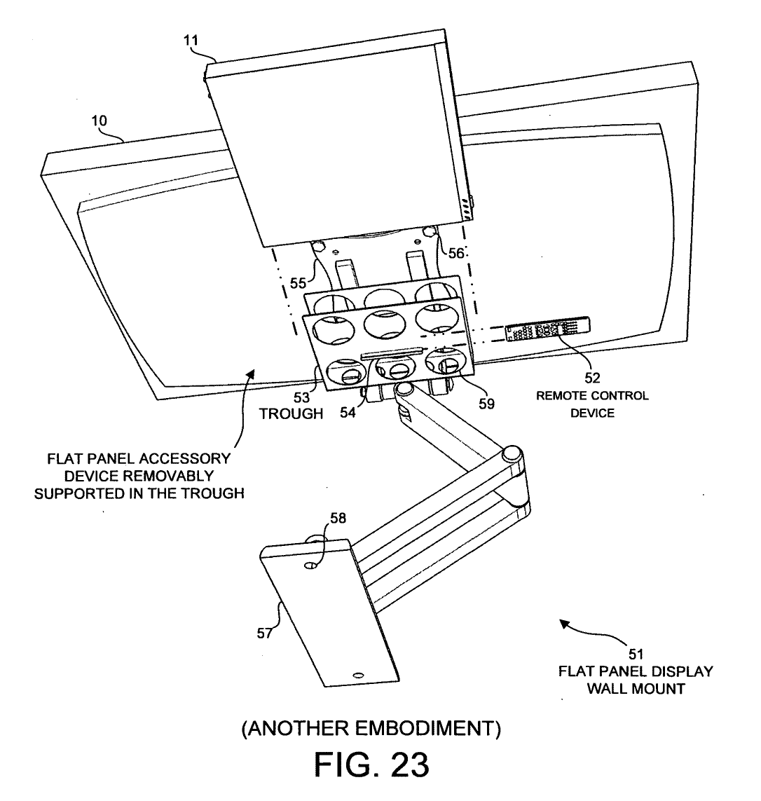

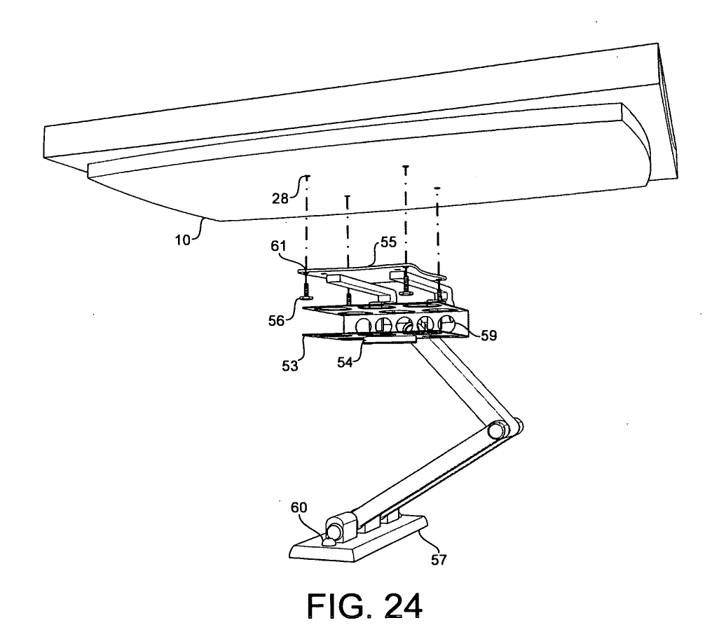

FIG. 23 is a diagram of another embodiment where the flat panel display wall mount supports a video flat panel device 10, a flat panel accessory device 11 and a remote control device 52. The display 10 attaches to the flat panel display wall mount 51, through the display attachment member 55. A trough 53, integrally formed on the wall mount 51, supports an accessory device 11 which may be inserted by the user into the trough 53. The trough 53 also contains a remote control retaining portion 54 which supports a remote control device 52. The remote control retaining portion 54 allows the user to store the remote control 52 in a location that is easily accessible, after they are finished using the device. The wall mount 51 attaches to a wall through the surface attachment member 57. Screws pass through holes 58 on the surface attachment member 57, and screw into the desired surface. FIG. 24 is an exploded perspective of the installed assembly. Four fasteners 56 pass through the four holes 61 located on the display attachment member 55, and screw into the four threaded holes 28 on the back of the flat panel display 10. Because the accessory device 11, as it is supported behind the display 10, is hidden from view, an IR repeater or similar mechanism can be used to operate the device with the remote control 52 (as in the embodiments described in FIG. 21 and FIG. 22).

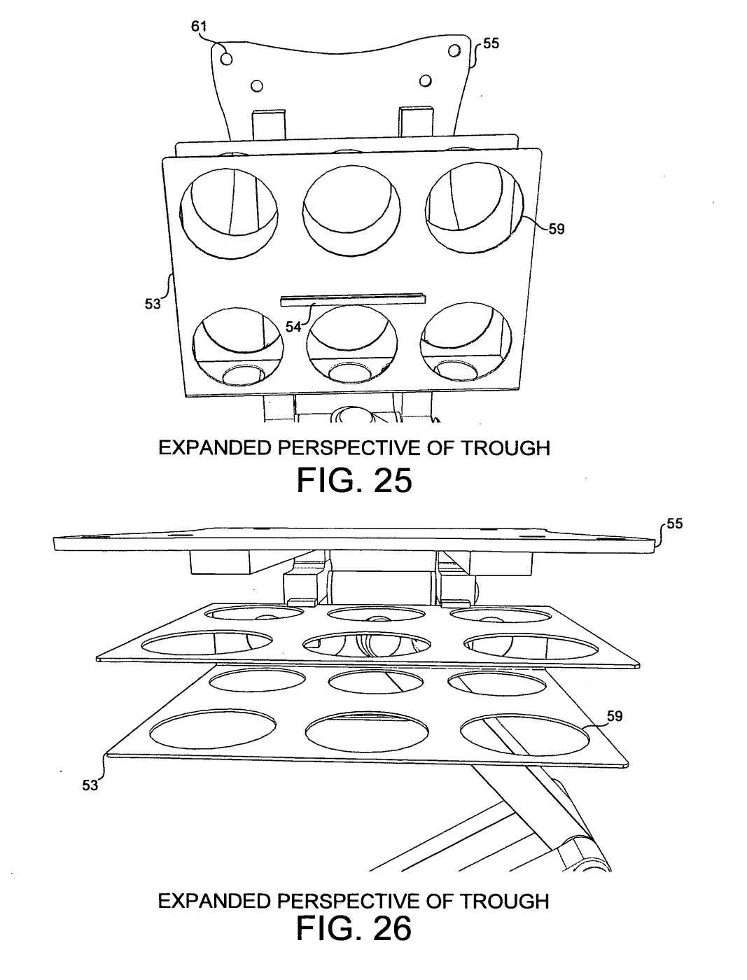

FIG. 25 and FIG. 26 are diagrams of an expanded back and top perspective of the trough 53, respectively. A user is able to insert the accessory device 11 into the trough 53 which supports the device. A remote control retaining portion 54 is formed on the trough 53 and supports a remote control 52. A user can store the remote control 52 and easily access it whenever the user requires it. Trough 53 also comprises a plurality of openings 59 which help reduce overall weight of the assembly by reducing the overall material weight. The plurality of openings 59 also provide for more air circulation around the surface of the accessory device 11 helping to cool the device during operation. Furthermore, the plurality of openings 59 allow the user to easily connect power cables and connection cables to the accessory device 11, as cables can easily pass through the openings 59 if necessary. Power cables and connection cables are not depicted in the figures.

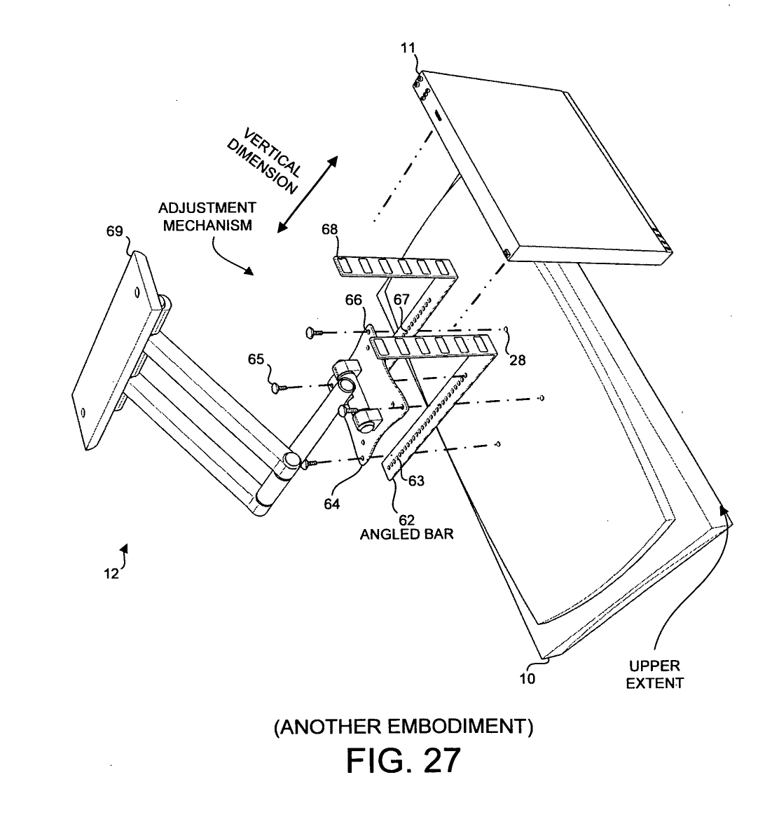

FIG. 27 is a diagram of an exploded perspective view of another embodiment providing the user with a kit to attach to a flat panel display wall mount 12, so that the wall mount 12 supports a flat panel accessory device 11 and a video flat panel display device 10. In this embodiment, the flat panel accessory device support member 62 is an angled bar. Angled bar is similar to the first described embodiment (FIG. 5-FIG. 13), except that instead of a single slit opening, angled bar 62 has a plurality of holes 63 providing the user an adjustment mechanism. The kit comprises a container used to store and transport the angled bars 62, and also comprises printed instructions for attaching the angled bar 62 to the wall mount 12. The container is riot depicted in the diagram, however it is substantially similar to the container diagramed in FIG. 5 and FIG. 6. The angled bars 62 support the accessory device 11 above the upper extent of the angled bar 62. A user slides angled bar 62 in a vertical dimension positioning the accessory device 11 at a desired location. The accessory device 11 is positioned above the upper extent of the display 10. Four fastners 65 are used to retain angled bars 62 between the display attachment member 64 and the back surface of the display 10. Fastners 65 pass through holes 66, then pass through holes 67 of the angled bar 62, then screw into the receiving threaded holes 28 located on the back of the display 10. Accessory device 11 rests on a plurality of non-slip pads 68 on the angled bars 62. Angled bars 62 are sandwiched between the surface attachment member 64 and the display 10, causing the accessory device 11 to be disposed above the upper extent of the display 10. The position of the accessory device 11 is adjustable in a vertical dimension. The assembly attaches to a wall through surface attachment member 69.

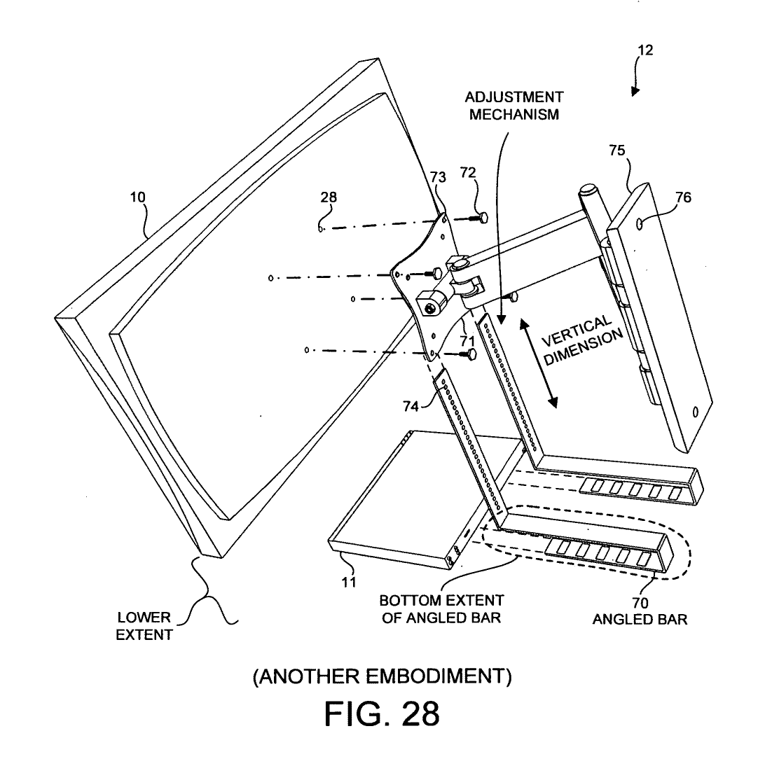

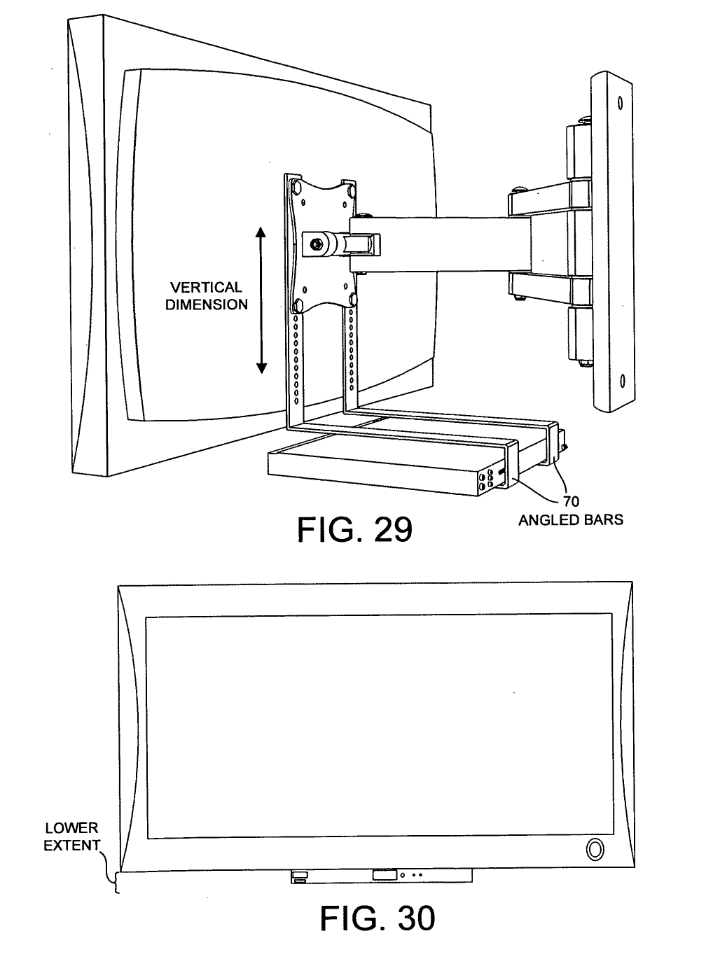

FIG. 28 is a diagram of an exploded perspective view of another embodiment, which provides the user with a kit to attach a video flat panel display device 10 and a flat panel accessory device 11 to a flat panel display wall mount 12. In this embodiment, the flat panel accessory device support member 70 is an angled bar. The kit comprises a container used to store and transport the angled bars 70, and also comprises printed instructions for attaching the angled bar 70 to the wall mount 12. Neither the container nor the printed instructions are depicted in the diagram, however they are substantially similar to the container and printed instructions diagramed in FIG. 5 and FIG. 6. The bottom extent of angled bar 70 contains a support for an accessory device 11. Angled bar 70 is retained in between the display attachment member 71 of the wall mount 12 and the back surface of the display 10. Four fasteners 72 pass through the four holes 73 located on the display attachment member 71, then pass through holes 74 located on the angled bar 70. The holes 74 chosen on the angled bar depend on the desired position of the angled bar. The accessory device 11 is inserted into the support portion located at the bottom extent of the angled bar 70. This causes the accessory device 11 to be disposed below the lower extent of the display 10. The plurality of holes provide the user with an adjustment mechanism, as the user can alter the location of the angled bars 70 in a vertical dimension. The wall mount 12 attaches to a wall through the surface attachment member 75, through screws which pass through holes 76, and screw into the wall. The kit comprises a container used to store and transport the angled bars 70, and also comprises printed instructions for attaching the angled bar 70 to the wall mount 12. The container is not depicted in the diagram, however it is substantially similar to the container diagramed in FIG. 5 and FIG. 6. FIG. 29 is a diagram of the side perspective after the kit is installed and the accessory device 11 and display 10 are attached. FIG. 30 is a diagram of the front perspective as viewed by a user after the kit is installed and the accessory device 11 and display 10 are attached. Power cables and connection cables are omitted from the figures.

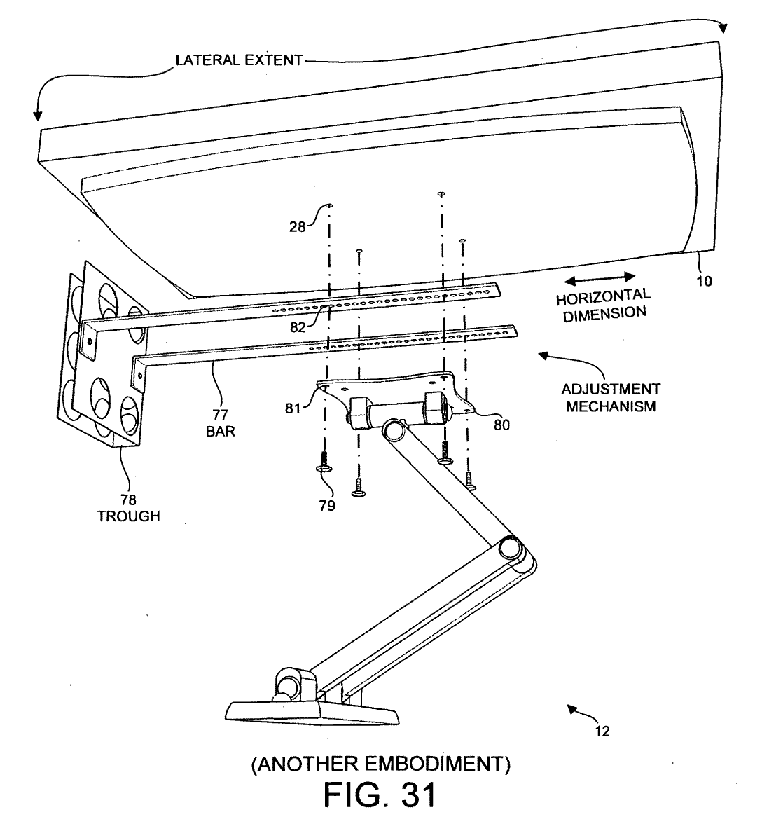

FIG. 31 is a diagram of an exploded perspective view of another embodiment, which provides the user with a kit to attach a video flat panel display device 10 and a flat panel accessory device 11 to a flat panel display wall mount 12. In this embodiment, the flat panel accessory device support member is comprised of a bar 77 and a trough 78. The kit comprises a container used to store and transport the trough 78, bar 77, nuts and bolts to attach the trough 78 to the bar 77, and also comprises printed instructions for attaching the trough 78 and bar 77 to the wall mount 12. Neither the container nor the printed instructions are depicted in the diagram, however they are substantially similar to the container and printed instructions diagramed in FIG. 5 and FIG. 6. The bar 77 is retained between the display attachment member 80 and the back surface of the display 10. Bar 77 has a plurality of holes 82, which provide the user with an adjustment mechanism to position the bar 77 at a desired location. Bar 77 is attached to trough 78 through a nut and bolt as diagramed in FIG. 35. The bar 77 is retained between the display attachment member 80 and the display 10 through four screws 79. Screw 79 passes through hole 81 on the display attachment member 80, then passes through the desired hole 82 on the bar 77, and finally screws into the threaded receiving hole 28 located on the back surface of the display 10. The trough supports the accessory device 11 (and a remote control 52) beside the lateral extent of the display 10. A user decides which four holes 82 to utilize, depending on where the user chooses to position the accessory device 11 along the lateral extent. A user places the accessory device 11 inside the trough 78. Power cables and connection cables are omitted from the diagrams.

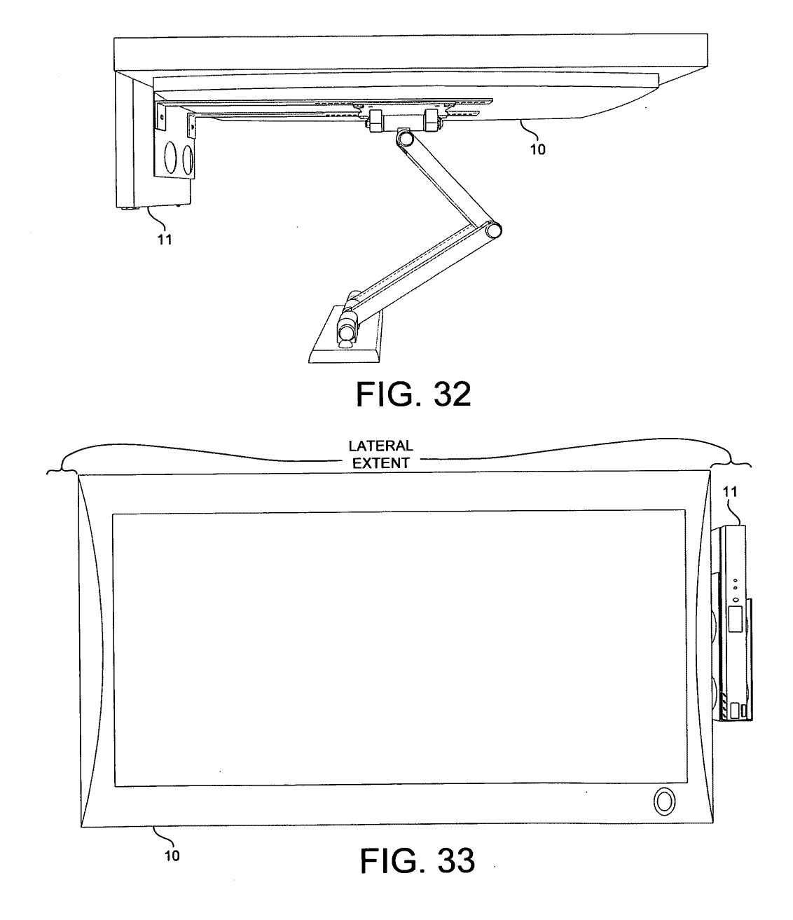

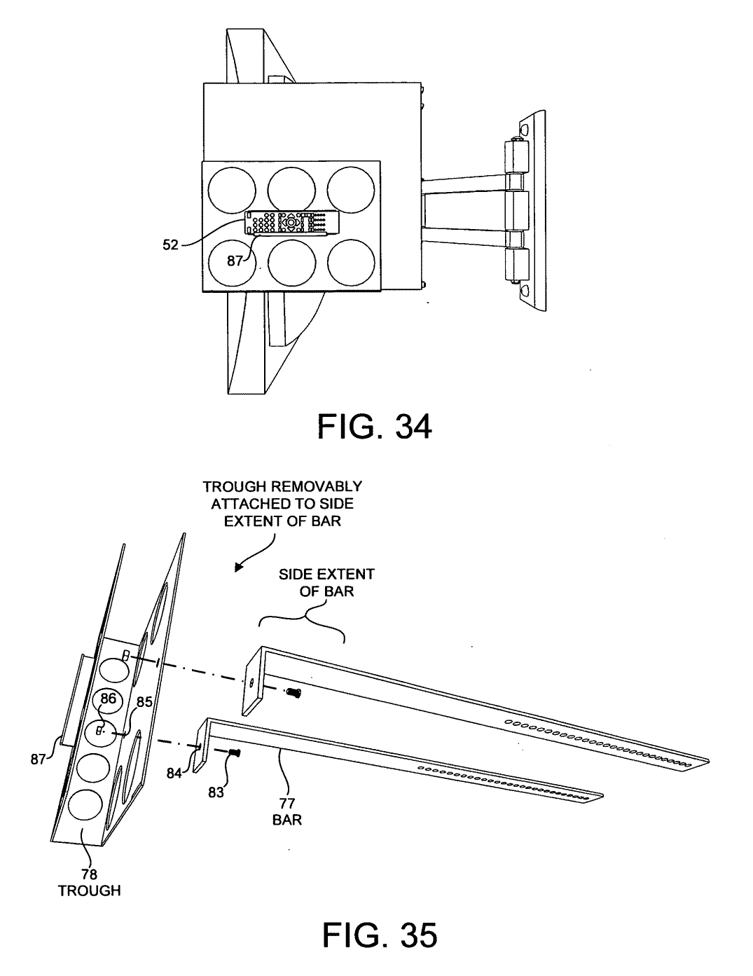

FIG. 32 is a diagram of a top perspective view after the kit is attached to the wall mount 12 and the accessory device 11 and display 10 are attached. FIG. 33 is a diagram of the front perspective as seen by a user facing the display, after the kit is attached to the wall mount 12 and the accessory device 11 and display 10 are attached. The adjustment mechanism allows the user to adjust the location of the accessory device 11 beside the lateral extent of the display 10. FIG. 34 is a diagram of the side perspective after the kit is attached to the wall mount 12, and the accessory device 11, remote control device 52, and display 10 are attached. FIG. 35 is an exploded perspective of the support member comprising a bar 77 and trough 78. The printed instructions in the kit instruct the user to attach the trough 78 to the bar 77 using bolts 83 and nuts 86. The side extent of the bar 77 contains a hole 84 which attaches to hole 85 located on the trough 78. Bolt 83 passes through hole 84, then pass through hole 85, and screws into a nut 86, effectively attaching the trough 78 to the bar 77. A user is able to removably attach the trough 78 to the side extent of the bar 77. Trough 78 also forms a remote control retaining portion 87, which allows the user to store a remote control device 52. A user places an accessory device 11 inside the trough 78 and can also choose to place a remote control device 52 in the remote control retaining portion 87.

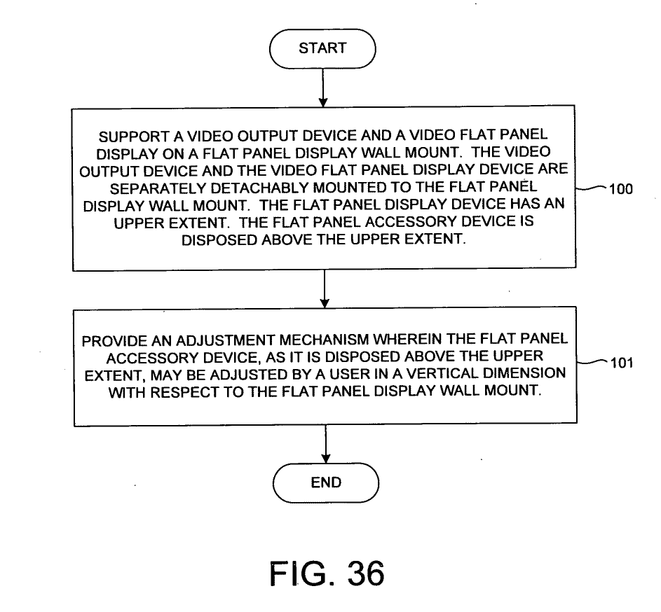

FIG. 36 is a simplified flowchart of a method in accordance with one novel aspect. A video output device and a video flat panel display are supported (step 100) on a flat panel display wall mount. The video output device can be the accessory device 11 of FIG. 7. The video flat panel display can be the display 10 of FIG. 7. The flat panel display wall mount can be the wall mount 12 of FIG. 7. The accessory device and display are separately detachably mounted to the wall mount, and the accessory device is disposed above the upper extent of the display, as in FIG. 7. An adjustment mechanism is provided (step 101) allowing a user to adjust the accessory device as it is disposed above the upper extent of the display, in a vertical dimension with respect to the wall mount. The adjustment mechanism can be the adjustment mechanism of FIG. 7.

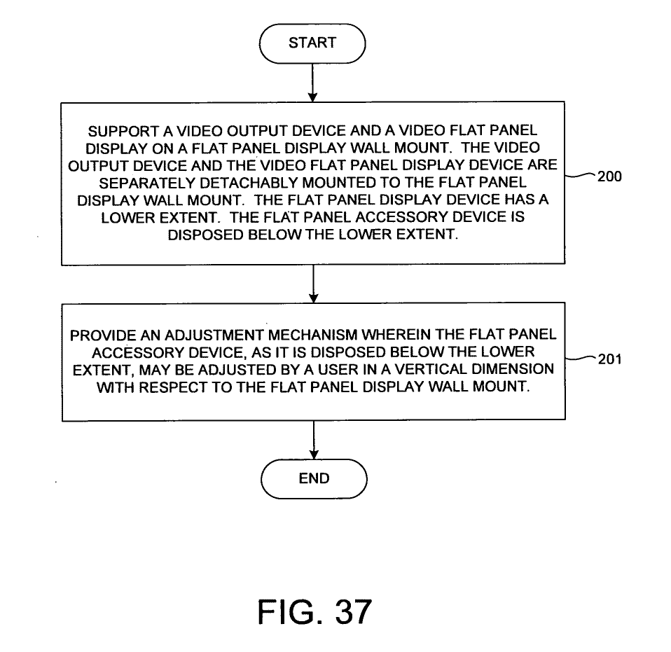

FIG. 37 is a simplified flowchart of a method in accordance with one novel aspect. A video output device and a video flat panel display are supported (step 200) on a flat panel display wall mount. The video output device can be the accessory device 11 of FIG. 28. The video flat panel display can be the display 10 of FIG. 28. The flat panel display wall mount can be the wall mount 12 of FIG. 28. The accessory device and display are separately detachably mounted to the wall mount, and the accessory device is disposed below the lower extent of the display, as in FIG. 28. An adjustment mechanism is provided (step 201) allowing a user to adjust the accessory device as it is disposed below the lower extent of the display, in a vertical dimension with respect to the wall mount. The adjustment mechanism can be the adjustment mechanism of FIG. 28.

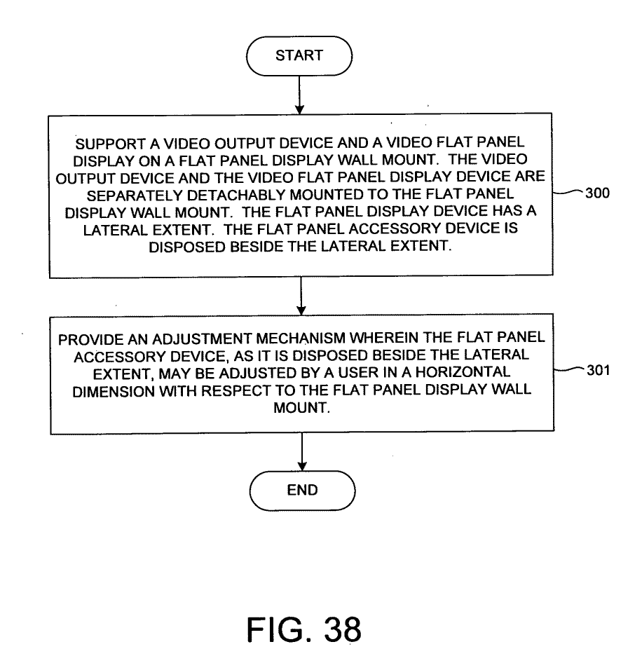

FIG. 38 is a simplified flowchart of a method in accordance with one novel aspect. A video output device and a video flat panel display are supported (step 300) on a flat panel display wall mount. The video output device can be the accessory device 11 of FIG. 33. The video flat panel display can be the display 10 of FIG. 33. The flat panel display wall mount can be the wall mount 12 of FIG. 31. The accessory device and display are separately detachably mounted to the wall mount, and the accessory device is disposed below the lower extent of the display, as in FIG. 33. An adjustment mechanism is provided (step 201) allowing a user to adjust the accessory device as it is disposed beside the lateral extent of the display, in a horizontal dimension with respect to the wall mount. The adjustment mechanism can be the adjustment mechanism of FIG. 31.

Although certain specific exemplary embodiments are described above in order to illustrate the invention, the invention is not limited to the specific embodiments. For example, the wall mount depicted in the figures may be structurally different. Various kinds of LCD wall mounts exist on the market for attaching a display to a wall or surface. For example, some support much larger LCD screens. Others vary in the number of pivot points, or in the angle of swivel and tilt they provide. Various kinds of accessory devices exist on the market which can be used in concert with the display. The accessory devices are not limited to the set-top boxes described. Additionally, figures depict only one set-top box supported, although multiple set-top boxes could be supported on a single LCD wall mount. The kit of FIG. 4 is not limited to the LCD wall mount of FIG. 7 and may attach to different types of LCD wall mounts. In another example, the kit in FIG. 5 may also include additional screws or fastening devices to attach the wall mount, support members, and display together. Dimensions of the support members, kit embodiments and modified LCD wall mounts vary and are dependent on the dimensions of the LCD display. For example, a kit designed for larger LCD screens will require longer support members in order to support a set-top box at the perimeter of the screen. Accordingly, various modifications, adaptations, and combinations of various features of the described embodiments can be practiced without departing from the scope of the invention as set forth in the claims.

What is claimed is:

1. A method comprising:
supporting a flat panel accessory device and a video flat panel display device on a flat panel display wall mount, wherein the flat panel accessory device and the video flat panel display device are separately detachably mounted to the flat panel display wall mount, and wherein the flat panel accessory device is taken from the group consisting of: a set-top box, a digital video recorder (DVR), a satellite set-top box, and a cable set-top box.

2. The method of claim 1, wherein the flat panel display device has an upper extent, and wherein the flat panel display wall mount supports the flat panel accessory device such that an infrared (IR) detector of the flat panel accessory device is disposed above the upper extent.

3. The method of claim 1, wherein the flat panel display device has an upper extent, wherein the flat panel accessory device is disposed above the upper extent.

4. The method of claim 3, further comprising:
providing an adjustment mechanism wherein the flat panel accessory device, as it is disposed above the upper extent, may be adjusted by a user in a vertical dimension with respect to the flat panel display wall mount.

5. The method of claim 1, wherein the flat panel display device has a lower extent, and wherein the flat panel accessory device is disposed below the lower extent.

6. The method of claim 5, further comprising:
providing an adjustment mechanism wherein the flat panel accessory device, as it is disposed below the lower extent, may be adjusted by a user in a vertical dimension with respect to the flat panel display wall mount.

7. The method of claim 1, wherein the flat panel display device has a lateral extent, and wherein the flat panel accessory device is disposed beside the lateral extent.

8. The method of claim 7, further comprising:
providing an adjustment mechanism wherein the flat panel accessory device, as it is disposed beside the lateral extent, may be adjusted by a user in a horizontal dimension with respect to the flat panel display wall mount.

9. The method of claim 1, further comprising:
supporting a remote control device on a flat panel display wall mount, wherein the remote control device is separately detachably mounted to the flat panel display wall mount.

10. An apparatus comprising:
flat panel display wall mount; and
means for supporting a flat panel accessory device and a video flat panel display device on the flat panel display wall mount such that the flat panel accessory device and the video flat panel display device are separately detachably mounted to the flat panel display wall mount, and wherein the flat panel accessory device is taken from the group consisting of: a set-top box, a digital video recorder (DVR), a satellite set-top box, a cable set-top box.

11. The apparatus of claim 10, wherein the means involves an element taken from the group consisting of: a non-slip surface, a non-slip contact, a velcro attachment mechanism, a tape attachment mechanism, a fastener, a screw, an angled bracket, a strap, a belt, and a substantially similar fastening device.

12. The apparatus of claim 11, wherein the means is an angled bar that slidably engages a portion of the flat panel display wall mount such that an upper extent of the angled bar is adjustable in a vertical dimension with respect to the flat panel display wall mount.

13. The apparatus of claim 11, wherein the means is an angled bar that slidably engages a portion of the flat panel display wall mount such that a bottom extent of the angled bar is adjustable in a vertical dimension with respect to the flat panel display wall mount.

14. The apparatus of claim 11, wherein the means involves a bar and a trough, wherein the trough is removably attached to a side extent of the bar, wherein the flat panel accessory device is removably supported in the trough, and wherein the bar slidably engages a portion of the flat panel display wall mount such that the side extent of the bar is adjustable in a horizontal dimension with respect to the flat panel display wall mount.

15. The apparatus of claim 11, wherein the means forms a trough, and wherein the flat panel accessory device is removably supported in the trough.

16. The apparatus of claim 11, wherein the flat panel display wall mount includes a display attachment member, wherein the display attachment member and the means are integrally formed, and wherein the means is a laterally extending portion of the display attachment member.

17. The apparatus of claim 11, wherein the means provides support for a plurality of flat panel accessory devices.

18. A kit, comprising:
a flat panel accessory device support member;
printed instructions that instruct a user to attach the flat panel accessory device support member to a flat panel display wall mount and to dispose a flat panel accessory device on the flat panel accessory device support member; and
a container that contains the flat panel accessory device support member and the printed instructions.

19. The kit of claim 18, wherein the printed instructions inform the user that the flat panel accessory device support member as it is attached to the flat panel display wall mount may be adjusted in a vertical dimension with respect to the flat panel display wall mount.

20. The kit of claim 18, wherein the printed instructions inform the user that the flat panel accessory device support member as it is attached to the flat panel display wall mount may be adjusted in a horizontal dimension with respect to the flat panel display wall mount.
